(19) United States
(12) Patent Application Publication
(10) Pub. No.: US 2026/0338240 A1
(43) Pub. Date: Oct. 29, 2026

(54) CLUTCH CONTROL DEVICE

(71) Applicant: HONDA MOTOR CO., LTD., Minato-ku, Tokyo (JP)

(72) Inventors: Takashi Kudo, Tokyo (JP); Junya Ono, Tokyo (JP); Yasushi Fujimoto, Tokyo (JP)

(21) Appl. No.: 19/110,817

(22) PCT Filed: Sep. 28, 2023
(86) PCT No.: PCT/JP2023/035533

§ 371 Date: Mar. 12, 2025

(30) Foreign Application Priority Data
Sep. 29, 2022 (JP) 2022-156061

(51) Int. Cl. F16D 48/06; F16D 23/12

(52) U.S. Cl. CPC F16D 48/06; F16D 2023/123; F16D 2300/24; F16D 2300/26

(57) ABSTRACT

This clutch control device includes a clutch device (26) configured to disconnect and connect motive power transmission between a prime mover (13) and an output target (21) of a machine (1) and a clutch actuator (50) configured to output a drive force for actuating the clutch device (26). The clutch actuator (50) includes an electric motor (52) serving as a drive source, a release shaft (53) configured to rotate in response to an input from the electric motor (52), and a reduction gear mechanism (51) configured to establish a connection between the electric motor (52) and the release shaft (53). A drive shaft (55) of the electric motor (52), the release shaft (53), and center shafts (56c, 57c, and 58c) of gears of the reduction gear mechanism (51) are parallel to each other in an axial direction and axial centers (C0, C1, C2, C3, and C4) are arranged on the same straight line (T1) as seen in the axial direction.

### TECHNICAL FIELD

The present invention relates to a clutch control device.

The present application claims priority based on Japanese Patent Application No. 2022-156061 filed on Sep. 29, 2022, the contents of which are incorporated herein by reference.

### BACKGROUND ART

Conventionally, a clutch control device in which a disconnection/connection manipulation of a clutch device is automatically performed according to electrical control is known (see, for example, Patent Document 1).

### RELATED ART DOCUMENT

### Patent Document

Patent Document 1: Japanese Unexamined Patent Application, First Publication No. 2005-106246

### SUMMARY

### Problems to Be Solved By The Invention

In the conventional technology, a clutch actuator including a motor is arranged on a front side of an engine and the clutch actuator and a release mechanism are connected via a manipulation cable. Thereby, although a degree of freedom in the arrangement of the clutch actuator can be increased, the number of parts increases due to a transmission part such as the manipulation cable.

For this reason, it is conceivable to eliminate the transmission part by making the clutch actuator close to the clutch device. However, because the clutch actuator easily projects in a vehicle width direction, it is desirable to arrange the clutch actuator as compactly as possible.

An objective of the present invention is to provide a clutch control device for enabling a clutch actuator to be compactly arranged. The purpose of the present application is to improve manipulability by solving the above problem. Accordingly, it will further improve traffic safety and contribute to the development of a sustainable transportation system.

### Means For Solving the Problem

As the means for solving the above-described problems, aspects of the present invention have the following configurations.
(1) According to an aspect of the present invention, there is provided a clutch control device including: a clutch device (26) configured to disconnect and connect motive power transmission between a prime mover (13) and an output target (21) of a machine (1); and a clutch actuator (50) configured to output a drive force for actuating the clutch device (26), wherein the clutch actuator (50) includes an electric motor (52) serving as a drive source, a release shaft (53) configured to rotate in response to an input from the electric motor (52), and a reduction gear mechanism (51) configured to establish a connection between the electric motor (52) and the release shaft (53), and wherein a drive shaft (55) of the electric motor (52), the release shaft (53), and center shafts (56c, 57c, and 58c) of gears of the reduction gear mechanism (51) are parallel to each other in an axial direction and axial centers (C0, C1, C2, C3, and C4) are arranged on the same straight line (T1) as seen in the axial direction.

According to the clutch control device described in the above-described (1) of the present invention, the axes of the electric motor, the release shaft, and the reduction gear mechanism of the clutch actuator are mutually arranged on the same straight line, such that it is possible to suppress an increase in a width of the clutch actuator in a direction orthogonal to an arrangement direction of the electric motor, the release shaft, and the reduction gear mechanism. Thus, when a direction orthogonal to the arrangement direction of the electric motor, the release shaft, and the reduction gear mechanism is a width direction of the machine, an increase in an amount of overhang of the clutch actuator in the width direction of the machine can be suppressed and the machine including the clutch actuator can be miniaturized.
(2) In the clutch control device according to the above-described (1), a plurality of electric motors (52) are provided and drive shafts (55) of the electric motors (521 and 522) are parallel to each other in the axial direction and axial centers (C01 and C02) are arranged on the straight line (T1) as seen in the axial direction, the clutch actuator (50) includes a first case (66a) configured to form an electric motor accommodation chamber (66d) configured to accommodate the plurality of electric motors (52), and a second case (66b) configured to form gear accommodation chambers (68d and 69d) configured to accommodate the reduction gear mechanism (51), the gear accommodation chambers (68d and 69d) include a first gear accommodation chamber (68d) formed on an opposite side of the first case (66a) in the axial direction and a second gear accommodation chamber (69d) formed on a first case (66a) side in the axial direction, a drive gear (55a) projecting into the second gear accommodation chamber (69d) is provided on the drive shaft (55) of each of the plurality of electric motors (52), the reduction gear mechanism (51) includes a single input gear (57a) arranged between two or more drive gears (55a) in the second gear accommodation chamber (69d) and configured to mesh with the two or more drive gears (55a), and an input shaft (57c) held in the second case (66b) and configured to have one side in the axial direction projecting into the second gear accommodation chamber (69d) and support the input gear (57a) on the one side in the axial direction, the input shaft (57c) that is the center shaft of the input gear (57a) and a plurality of drive shafts (55) have axial centers arranged on the straight line (T1) as seen in the axial direction, the first case (66a) and the second case (66b) are mutually positioned via a plurality of knock pins (71), and the plurality of knock pins (71) have axial centers (C5) arranged on the straight line (T1) as seen in the axial direction.

According to the clutch control device described in the above-described (2) of the present invention, even in a configuration in which drive gears of a plurality of electric motors accommodated in the first case are meshed with a single input gear supported by the second case, the plurality of knock pins are arranged on the straight line on which the plurality of drive gears and the single input gear are arranged and the first case and the second case are positioned. Thereby, in a state in which the electric motor is assembled in the first case, a plurality of drive gears can be accurately meshed with the single input gear on the second case side. Moreover, the overhang of each configuration of the clutch actuator in a direction orthogonal to the straight line (in the width direction of the machine) can be suppressed and the machine including the clutch actuator can be miniaturized.
(3) In the clutch control device according to the above-described (2), each of the plurality of knock pins (71) is held in one of the first case (66a) and the second case (66b) and a plurality of fitting holes (73) into which the knock pins (71) corresponding thereto are inserted are formed in the other of the first case (66a) and the second case (66b), and an insertion depth (D1) of each knock pin (71) into a corresponding fitting hole (73) is deeper than a meshing depth (D2) of each drive gear (55a) and the input gear (57a) in the axial direction.

According to the clutch control device described in the above-described (3) of the present invention, when the clutch actuator is assembled, if the first case and the second case are made close to each other in the axial direction, the knock pin is fitted into the fitting hole before the drive gear and the input gear are meshed. Thereby, the drive gear and the input gear can be meshed in the axial direction while the relative positions of the first case and the second case (and the relative positions of the drive gear and the input gear) are accurately determined, and the actuator assembly can be facilitated.
(4) In the clutch control device according to the above-described (2) or (3), in a direction orthogonal to the straight line (T1) as seen in the axial direction, each gear of the reduction gear mechanism (51) is arranged within a width (H1) of an accommodation portion (66) forming the electric motor accommodation chamber (66d) in the first case (66a).

According to the clutch control device described in the above-described (4) of the present invention, an increase in the size of each gear of the reduction gear mechanism is suppressed, such that the overhang of the clutch actuator can be suppressed in the direction orthogonal to the arrangement direction of the electric motor and the reduction gear mechanism and the machine including the clutch actuator can be miniaturized.
(5) The clutch control device according to the above-described (2) or (3) further includes a fixing member (67) fixed to the accommodation portion (66) forming the electric motor accommodation chamber (66d) in the first case (66a), wherein the fixing member (67) includes a fastening portion (67a) fastened to a machine-side portion (17a) in a direction orthogonal to the axial direction, and wherein the fastening portion (67a) forms a bolt insertion hole (67b) having an elliptical shape that is long in the axial direction.

According to the clutch control device described in the above-described (5) of the present invention, because the fixing member fixed to the accommodation portion of the first case is fastened using a long hole that is long in the axial direction with respect to the machine, it is possible to attach the accommodation part to the machine while absorbing the part tolerance in the axial direction. The “machine-side portion” is a general term for a part fixed to a machine body side except for the clutch actuator.
(6) The clutch control device according to any one of the above-described (1) to (3) further includes a machine cover (17a) attached to the clutch case (15) and configured to cover the clutch device (26) from one side of the machine (1) in a width direction, wherein a joint surface (S1) between the machine cover (17a) and the clutch case (15) is inclined with respect to a forward/rearward direction of the vehicle in a top view of the machine (1), and wherein, in the top view, the clutch actuator (50) is arranged to fit between a first virtual line (K1) along the joint surface (S1) and a second virtual line (K2) parallel to the first virtual line (K1) and passing through an outer side end (17b1) of the machine cover (17a) in the width direction.

According to the clutch control device described in the above-described (6) of the present invention, an increase in the amount of overhang of the machine in the width direction can be suppressed and an increase in the width of the small assembly between the clutch actuator and the machine cover can be suppressed.

### Advantage of the Invention

According to an aspect of the present invention, a clutch control device for enabling a clutch actuator to be compactly arranged can be provided.

### BRIEF DESCRIPTION OF THE DRAWINGS

FIG. 1 is a right side view of a two-wheeled motor vehicle of the present embodiment.

FIG. 2 is a cross-sectional view of a transmission and a change mechanism of the two-wheeled motor vehicle.

FIG. 3 is a block diagram of a transmission system of the two-wheeled motor vehicle.

FIG. 4 is an explanatory diagram showing the transition of a clutch control mode of the two-wheeled motor vehicle.

FIG. 5 is a cross-sectional view in an axial direction of a clutch actuator.

FIG. 6 is an explanatory view of an upper-stage portion of a gear case of the clutch actuator seen in an axial direction.

FIG. 7 is an explanatory diagram of a lower-stage portion of the gear case of the clutch actuator seen in the axial direction.

FIG. 8 is a perspective view of a release shaft for operating the clutch device.

FIG. 9 is a cross-sectional view of IX-IX in FIG. 8.

FIG. 10A is a cross-sectional view corresponding to FIG. 9 showing the action of the release shaft in a half-clutch region and showing the time of drive of the clutch actuator.

FIG. 10B is a cross-sectional view corresponding to FIG. 9 showing the action of the release shaft in the half-clutch region and showing the time of manual intervention. FIG. 11A is a cross-sectional view corresponding to FIG. 9 showing the action of the release shaft at a standby position and showing the time of drive of the clutch actuator.

FIG. 11B is a cross-sectional view corresponding to FIG. 9 showing the operation of the release shaft at the standby position and showing the time of manual intervention.

FIG. 12A is a cross-sectional view of a state in which a first case body and a second case body of the clutch actuator are disassembled.

FIG. 12B is a cross-sectional view of the clutch actuator during the assembly of the first case body and the second case body.

FIG. 13 is a right side view of the small assembly of the clutch actuator and a right cover.

FIG. 14 is a right side view of the right cover.

FIG. 15 is a plan view of a state in which the small assembly of the clutch actuator and the right cover are removed from a crankcase.

### DESCRIPTION OF THE EMBODIMENTS

Hereinafter, embodiments of the present invention will be described with reference to the drawings. In addition, it is assumed that the orientation of the front, rear, left, right, or the like in the following description is the same as the orientation of a vehicle to be described below unless otherwise described. In the drawings used in the following description, an arrow FR indicating a forward direction of the vehicle, an arrow LH indicating a left direction of the vehicle, an arrow UP indicating an upward direction of the vehicle, and a line CL indicating a center of left and right sides of a vehicle body are shown. As used in the present embodiment, the term “intermediate” includes an inner range between two ends of a target as well as a center between two ends of the target.

### Overall Configuration of Vehicle

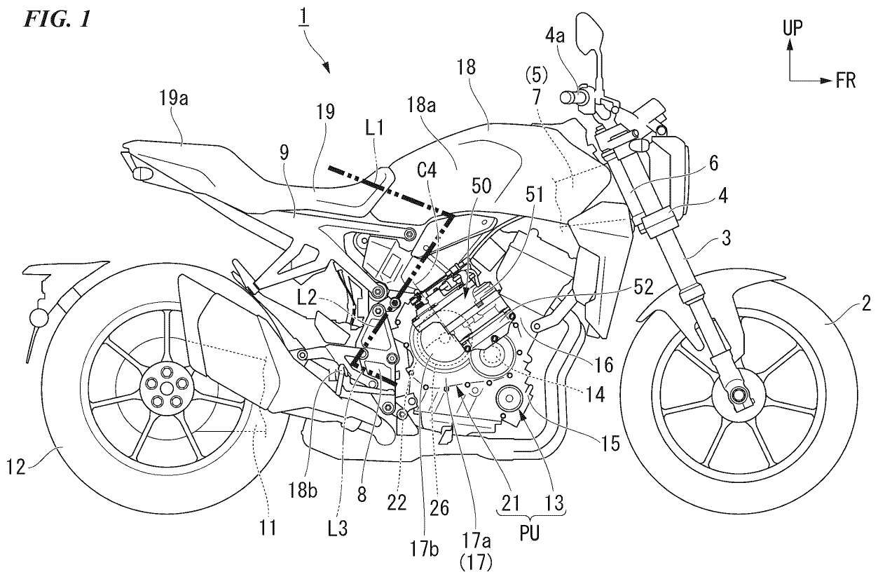

As shown in FIG. 1, the present embodiment is applied to a two-wheeled motor vehicle 1 as an example of a saddle-riding vehicle. A front wheel 2 of the two-wheeled motor vehicle 1 is supported by a lower end portion of a left and right pair of front forks 3. An upper portion of the left and right front forks 3 is supported by a head pipe 6 at a front end portion of a vehicle body frame 5 via the steering stem 4. On a top bridge of the steering stem 4, a bar-type steering handle 4a is attached.

The vehicle body frame 5 includes the head pipe 6, a main frame 7 extending downward and backward from the head pipe 6 in a center of a vehicle width direction (a left/right direction), a pivot frame 8 provided below a rear end portion of the main frame 7, and a seat frame 9 connected to the rear of the main frame 7 and the pivot frame 8. In the pivot frame 8, the front end portion of the swingarm 11 is pivotally supported so that swing is possible. A rear wheel 12 of the two-wheeled motor vehicle 1 is supported on the rear end portion of the swingarm 11.

Above the left and right main frames 7, a fuel tank 18 is supported. A front seat 19 and a rear seat 19a are supported above the seat frame 9 behind the fuel tank 18. On the left and right sides of the rear of the fuel tank 18, a knee grip part 18a recessed inside the vehicle width direction is formed. The left and right knee grip parts 18a are formed to be consistent with the following parts. The parts are located inside of areas near left and right knees of a rider sitting in the front seat 19. Steps 18b are supported on both the left and right sides below the front seat 19. On the steps 18b, the rider places his/her feet extending forward from the ankles.

Below the main frame 7, a power unit PU including a prime mover of the two-wheeled motor vehicle 1 is suspended. The power unit PU integrally has an engine (an internal combustion engine or a prime mover) 13 located on the front side and a transmission (an output target) 21 located on the rear side. The engine 13 is, for example, a plurality of cylinder engines in which a rotation axis of a crankshaft 14 is arranged in the left/right direction (the vehicle width direction).

The engine 13 causes a cylinder 16 to stand up above a front portion of a crankcase 15. A rear portion of the crankcase 15 is formed as a transmission case 17 that accommodates the transmission 21. A right cover 17a that extends to a right side portion of the transmission case 17 is attached to the right side portion of the crankcase 15. A right cover 17a is also a clutch cover covering a clutch device 26. The power unit PU is linked to the rear wheel 12, for example, via a chain-type transmission mechanism (not shown).

### Transmission

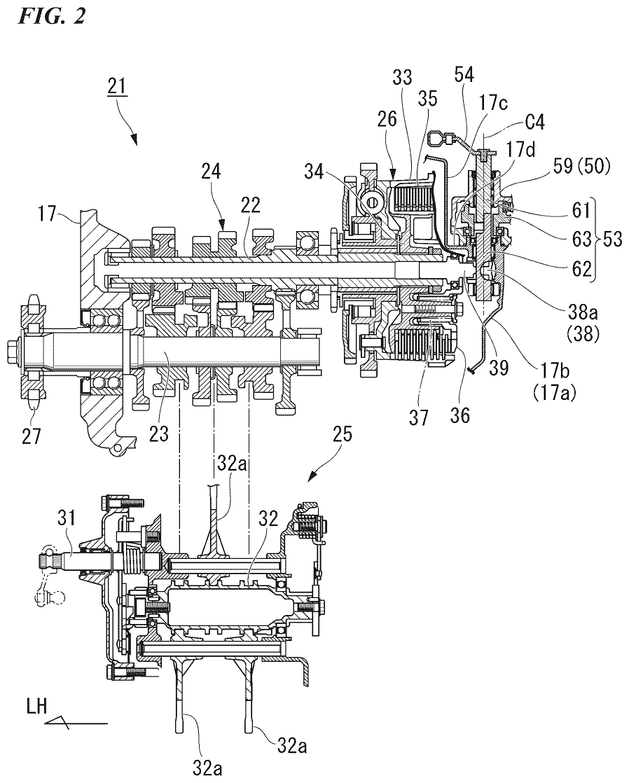

Referring also to FIG. 2, the transmission 21 is a stepped transmission. The transmission 21 includes a main shaft 22, a counter shaft 23, and a transmission gear group 24 that straddles both shafts 22 and 23. The counter shaft 23 constitutes an output shaft of the transmission 21 and the power unit PU. A left end portion of the counter shaft 23 projects to a rear left side of the transmission case 17 and is connected to the rear wheel 12 via the chain type transmission mechanism.

The main shaft 22 and the counter shaft 23 of the transmission 21 are arranged behind the crankshaft 14. At the right end portion of the main shaft 22, the clutch device 26 is coaxially arranged. The clutch device 26 disconnects the motive power transmission between the crankshaft 14 of the engine 13 and the main shaft 22 of the transmission 21. The clutch device 26 is disconnected and connected by at least one of an occupant's manipulation of a clutch manipulation element (e.g., the clutch lever not shown) and an actuation of a clutch actuator 50, which will be described in detail below.

The clutch device 26 is, for example, a wet multi-plate clutch and a so-called normally closed clutch. The rotational power of the crankshaft 14 is transmitted to the main shaft 22 via the clutch device 26 and transmitted from the main shaft 22 to the counter shaft 23 via any gear pair of the transmission gear group 24. A drive sprocket 27 of the chain type transmission mechanism is attached to the left end portion projected to the rear left side of the crankcase 15 in the counter shaft 23.

In the vicinity of the transmission 21 within the transmission case 17, a change mechanism 25 for switching the gear pair of the transmission gear group 24 is accommodated. The change mechanism 25 has a hollow cylindrical shift drum 32 parallel to both shafts 22 and 23. Due to the rotation of the shift drum 32, the change mechanism 25 actuates a plurality of shift forks 32a. This actuation is performed in accordance with a pattern of a lead groove formed on the outer circumference of the shift drum 32. According to this actuation, the change mechanism 25 switches the gear pair for use in the motive power transmission between the two shafts 22 and 23 in the transmission gear group 24.

In the two-wheeled motor vehicle 1, the rider performs only the gear shifting manipulation of the transmission 21 (a foot manipulation of a shift pedal (not shown)) and a disconnection/connection manipulation of the clutch device 26 is automatically performed by electric control in accordance with the manipulation of the shift pedal. That is, the two-wheeled motor vehicle 1 employs a so-called semi-automatic transmission system (automatic clutch type transmission system).

### Transmission System

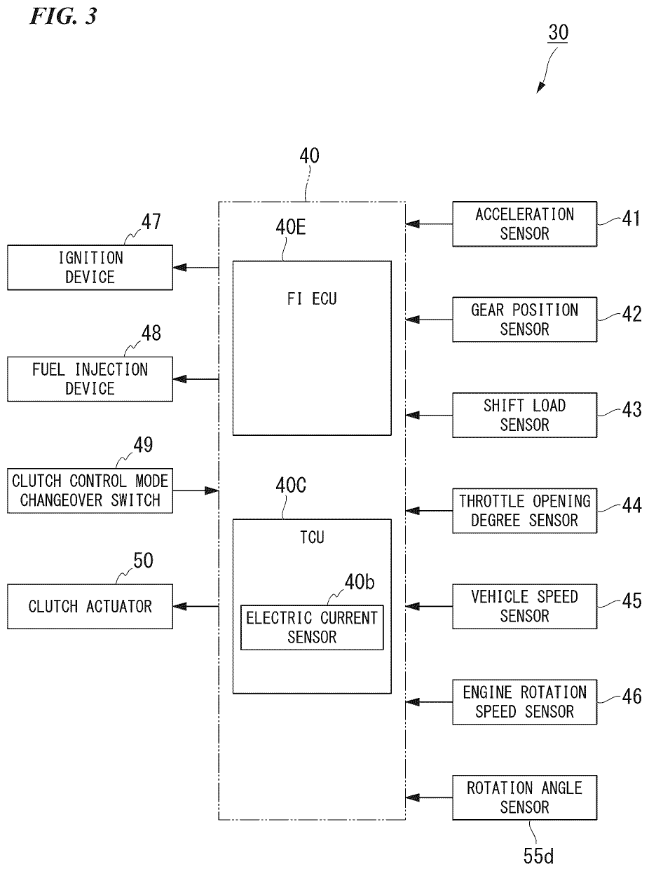

As shown in FIG. 3, a transmission system 30 includes the clutch actuator 50, a control portion 40, various types of sensors 41 to 46, and various types of devices 47, 48, and 50.

The control portion 40 controls the actuations of the ignition device 47 and the fuel injection device 48 and controls the actuation of the clutch actuator 50. This control is based on detection information from the acceleration sensor 41, the gear position sensor 42, and the shift load sensor 43 (for example, the torque sensor), various types of vehicle state detection information from the throttle opening degree sensor 44, the vehicle speed sensor 45, the engine speed sensor 46, and the like.

The acceleration sensor 41 detects the behavior of the vehicle body. The gear position sensor 42 detects a variable speed level from a rotation angle of a shift drum 32. The shift load sensor 43 detects a manipulation torque input to the shift spindle 31 (see FIG. 2) of the change mechanism 25. The throttle opening degree sensor 44 detects a throttle opening degree. The vehicle speed sensor 45 detects a vehicle speed. The engine speed sensor 46 detects an engine speed.

The control portion 40 includes a clutch control portion 40C and an engine control portion 40E that are independent of each other. The clutch control portion 40C mainly controls the drive of the clutch actuator 50. The engine control portion 40E mainly controls the drive of the engine 13. The clutch control portion 40C and the engine control portion 40E, for example, are configured as electronic control units (ECUs) separate from each other. The clutch control portion 40C and the engine control portion 40E may be configured in an integrated ECU as long as they are controlled independently of each other.

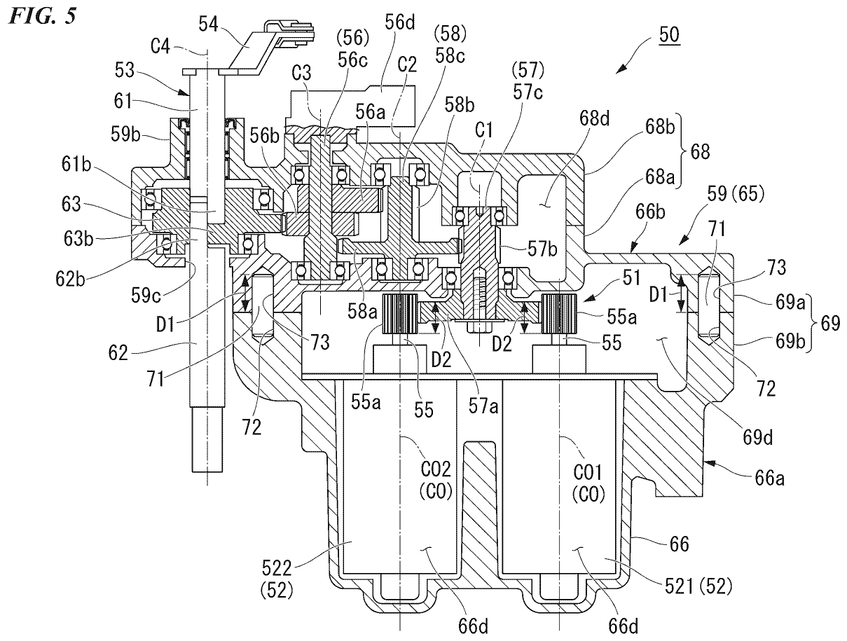

Referring to FIGS. 2 and 5 together, the clutch actuator 50 controls an actuating torque applied to a release shaft 53 so that the clutch device 26 is disconnected and connected. The clutch actuator 50 includes an electric motor 52 (hereinafter simply referred to as a motor 52) serving as a drive source and a deceleration mechanism (a reduction gear mechanism) 51 that transmits the drive force of the motor 52 to the release shaft 53. The deceleration mechanism 51 includes a first reduction shaft 57, a second reduction shaft 58, and a third reduction shaft 56. For example, a rotation angle sensor 56d configured to detect the rotation angle of the third reduction shaft 56 is provided on the third reduction shaft 56.

Referring to FIG. 3, the clutch control portion 40C calculates the following electric current value on the basis of a preset calculation program. The electric current value is a value of an electric current supplied to the motor 52 for disconnecting and connecting the clutch device 26. The electric current supplied to the motor 52 is obtained from a correlation with the torque output to the motor 52. A target torque of the motor 52 is proportional to an actuating torque (a driven clutch lever torque to be described below) applied to the release shaft 53. The electric current value supplied to the motor 52 is detected by an electric current sensor 40b included in the clutch control portion 40C. In accordance with a change in this detected value, the clutch actuator 50 is actuated and controlled. The clutch actuator 50 will be described in detail below.

### Clutch Device

As shown in FIG. 2, the clutch device 26 of the embodiment is a multi-plate clutch in which a plurality of clutch plates 35 are laminated in the axial direction, and is a wet clutch arranged in an oil chamber in the right cover 17a. The clutch device 26 includes a clutch outer 33, a clutch center 34, and a plurality of clutch plates 35.

The clutch outer 33 is driven by rotational motive power constantly transmitted from the crankshaft 14. The clutch center 34 is arranged in the clutch outer 33 and integrally rotatably supported by the main shaft 22. A plurality of clutch plates 35 are laminated between the clutch outer 33 and the clutch center 34 so that they are frictionally engaged with each other.

A pressure plate 36 having substantially the same diameter as the clutch plate 35 is arranged on the right side of the laminated clutch plate 35 (on an outer side in the vehicle width direction). The pressure plate 36 is applied to the left under the bullet load of the clutch spring 37 and the laminated clutch plates 35 are pressure-welded to (frictionally engaged with) each other. Thereby, the clutch device 26 is in a connection state in which motive power can be transmitted. The clutch device 26 is a normally closed clutch that is connected at normal times without any external input.

The release of the pressure welding (frictional engagement) is performed by actuating the release mechanism 38 inside the right cover 17a. The actuation of the release mechanism 38 is performed by at least one of the actuation of a clutch lever (not shown) by the occupant and the application of a torque by the clutch actuator 50.

### Release Mechanism

As shown in FIG. 2, the release mechanism 38 includes a lifter shaft 39 and a release shaft 53.

The lifter shaft 39 is held so that the lifter shaft 39 can reciprocate in the axial direction within the right side portion of the main shaft 22. The release shaft 53 is arranged orthogonally to the lifter shaft 39 in the axial direction and is held rotatably around the axial center on the outer side portion of the right cover 17a.

In the drawing, a line C4 indicates a center axis of the release shaft 53 extending in the vertical direction. The release shaft 53 tilts the axial direction backward so that it is located on a rear side in the proximity of the upper side in the vertical direction in an axial view of the main shaft 22 (a vehicle side view) (see FIG. 1). The upper portion of the release shaft 53 projects to an outer side of the right cover 17a and the driven clutch lever 54 is integrally rotatably attached to the upper portion of the release shaft 53. The driven clutch lever 54 is connected to the clutch lever via a manipulation cable (not shown).

An eccentric cam portion 38a is provided in a lower portion located inside the right cover 17a in the release shaft 53. The eccentric cam portion 38a engages with the right end portion of the lifter shaft 39. The release shaft 53 moves the lifter shaft 39 to the right by the action of the eccentric cam portion 38a by rotating around the shaft center. The lifter shaft 39 is configured so that the lifter shaft 39 can integrally reciprocate with the pressure plate 36 of the clutch device 26. Therefore, when the lifter shaft 39 moves to the right, the pressure plate 36 is moved (lifted) to the right against a biasing force of the clutch spring 37. Thereby, the frictional engagement between the laminated clutch plates 35 is released. Thereby, the clutch device 26 that is normally closed is in a disconnected state in which motive power transmission is not possible.

The release mechanism 38 is not limited to an eccentric cam mechanism, but may include a rack & pinion, a feed screw, or the like. A mechanism for connecting the clutch lever and the driven clutch lever 54 may not be limited to a manipulation cable, but may include a rod, a link, or the like.

### Clutch Control Mode

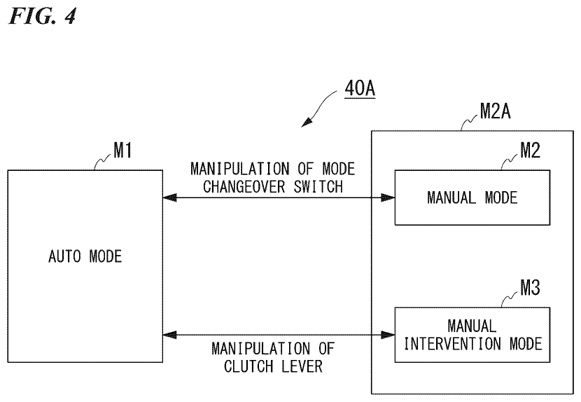

As shown in FIG. 4, the clutch control device 40A of the present embodiment has three clutch control modes. The clutch control mode includes an auto mode M1 in which automatic control is performed, a manual mode M2 in which a manual manipulation is performed, and a manual intervention mode M3 in which a temporary manual manipulation is performed. The clutch control mode transitions appropriately between the three modes in accordance with a manipulation of the clutch control mode changeover switch 49 (see FIG. 3) and the clutch manipulation element. A target including the manual mode M2 and the manual intervention mode M3 is referred to as a manual system M2A.

The auto mode M1 is a mode in which the clutch device 26 is controlled by calculating a clutch capacity suitable for a movement state in accordance with the automatic start/shift control. The manual mode M2 is a mode in which the clutch capacity is calculated in accordance with a clutch manipulation instruction from the occupant and the clutch device 26 is controlled. The manual intervention mode M3 is a mode in which a clutch manipulation instruction is received from the occupant during the auto mode M1, the clutch capacity is calculated from the clutch manipulation instruction, and the clutch device 26 is controlled, and is a temporary manual manipulation mode.

In addition, a process of returning to the auto mode M1 may be performed, for example, if the occupant stops the manipulation of the clutch manipulation element (a fully released state) for a specified period of time during the manual intervention mode M3.

For example, when the system is activated, the clutch control device 40A starts control from the clutch-on state (a connected state) in the auto mode M1. Moreover, the clutch control device 40A is set to return to the clutch-on state in the auto mode M1 when the engine 13 is stopped (when the system is turned off). In the normally closed clutch device 26, when the clutch is turned on, electric power supply to the motor 52 of the clutch actuator 50 is not required. On the other hand, in the clutch-off state (disconnected state) of the clutch device 26, the electric power supply to the motor 52 is held.

In the auto mode M1, the clutch control is basically performed automatically. The auto mode M1 enables the two-wheeled motor vehicle 1 to move without any lever manipulation. In the auto mode M1, the clutch capacity is controlled on the basis of a throttle opening degree, an engine speed, a vehicle speed, a shift sensor output, or the like. Thereby, the two-wheeled motor vehicle 1 can be started without any stalling (indicating the engine stop or engine stall) simply by performing a throttle manipulation. Moreover, the speed of the two-wheeled motor vehicle 1 can be shifted with only a shift manipulation. Moreover, in the auto mode M1, the occupant switches the mode to the manual intervention mode M3 by holding the clutch lever. Thereby, it is possible to arbitrarily disconnect the clutch device 26.

On the other hand, in the manual mode M2, the clutch capacity can be controlled according to a lever manipulation by the occupant (i.e., the clutch device 26 can be disconnected and connected). The auto mode M1 and the manual mode M2 can be mutually switched. This switching is made, for example, by manipulating the clutch control mode changeover switch 49 (see FIG. 3) while the two-wheeled motor vehicle 1 is stopped and the transmission 21 is in neutral. In addition, the clutch control device 40A may include an indicator indicating a manual state at the time of transition to a manual system M2A (the manual mode M2 or the manual intervention mode M3).

In the manual mode M2, the clutch control is basically performed manually. In the manual mode M2, the clutch capacity can be controlled in accordance with an actuation angle of the clutch lever (and an actuation angle of the driven clutch lever 54). Thereby, it is possible to control the disconnection/connection of the clutch device 26 according to the will of the occupant. Even in the manual mode M2, clutch control can automatically intervene when a shift manipulation is performed without any clutch manipulation. Hereinafter, the actuation angle of the driven clutch lever 54 is referred to as a driven clutch lever actuation angle.

In the auto mode M1, the clutch device 26 is automatically disconnected and connected by the clutch actuator 50. In this case, a manual clutch manipulation on the clutch lever is performed, such that a manual manipulation can be allowed to be temporarily intervene in the automatic control of the clutch device 26 (the manual intervention mode M3).

Manual Clutch Manipulation

In the two-wheeled motor vehicle 1 shown in FIG. 1, a clutch lever (not shown) as a manual clutch manipulation element is attached to the proximal end side of the left grip of the steering handle 4a (inside the vehicle width direction).

Referring also to FIG. 2, the clutch lever is connected to the driven clutch lever 54 attached to the release shaft 53 of the clutch device 26 via the manipulation cable (not shown). The driven clutch lever 54 is integrally rotatably attached to an upper end portion projecting from the upper portion of the right cover 17a in the release shaft 53.

Moreover, for example, the clutch control mode changeover switch 49 is provided in a handle switch (not shown) attached to the steering handle 4a. Thereby, it is possible for the occupant to easily switch the clutch control mode during normal riding.

### Clutch Actuator

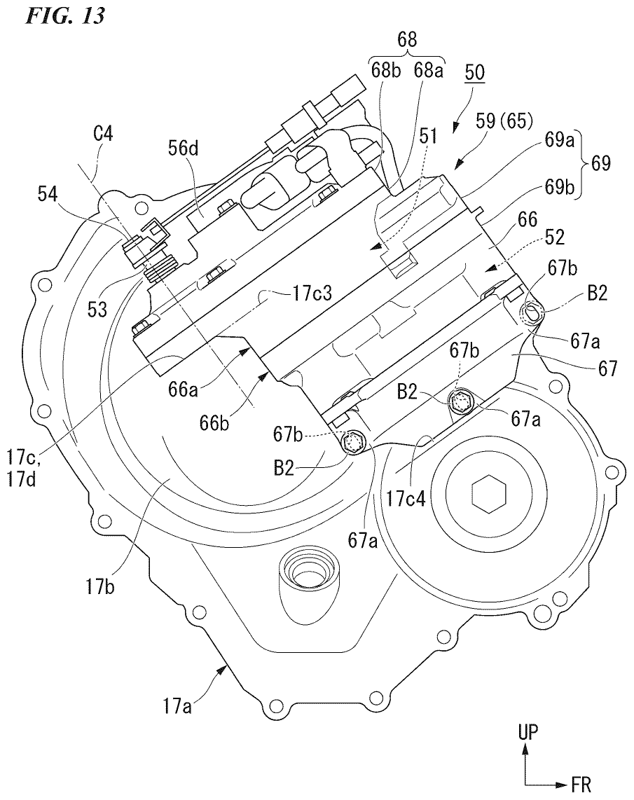

As shown in FIGS. 1 and 13, the clutch actuator 50 is attached to the upper portion of the right cover 17a on the right side of the crankcase 15.

Referring also to FIGS. 5 to 7, the clutch actuator 50 includes a motor 52 and a deceleration mechanism 51.

The motor 52 is, for example, a DC motor, and is arranged, for example, in parallel to the release shaft 53 in the axial direction. The motor 52 is arranged so that the drive shaft 55 is projected upward. The deceleration mechanism 51 transmits the drive force of the motor 52 to the release shaft 53.

In the embodiment, a plurality of (two) motors 52 are provided for a single clutch actuator 50. Hereinafter, the motor 52 located on the front side of the vehicle for the clutch actuator 50 is referred to as a first motor 521 and the motor 52 located on a rear side of the vehicle and an inner side in the vehicle width direction with respect to the first motor 521 is referred to as a second motor 522. The lines C01 and C02 in the drawings indicate center axes (drive axes) of the motors 521 and 522, respectively. For illustrative convenience, both motors 521 and 522 may be collectively referred to as motors 52. Moreover, both axes C01 and C02 may be collectively referred to as axes CO. Control of the plurality of (two) motors 52 will be described below.

The deceleration mechanism 51 decelerates the rotational motive power output from the motor 52 and transmits a deceleration result to the release shaft 53. The deceleration mechanism 51 includes, for example, a gear array parallel to the release shaft 53 in the axial direction. The deceleration mechanism 51 includes a drive gear 55a, a first reduction gear 57a, a first small-diameter gear 57b, a second reduction gear 58a, a second small-diameter gear 58b, a third reduction gear 56a, a third small-diameter gear 56b, a driven gear 63a, and a gear case 59.

The drive gear 55a is integrally provided on the drive shaft 55 of each of the motors 521 and 522. The first reduction gear 57a meshes with each drive gear 55a. The first small-diameter gear 57b is provided coaxially with the first reduction gear 57a. The second reduction gear 58a meshes with the first small-diameter gear 57b. The second small-diameter gear 58b is provided coaxially with the second reduction gear 58a. The third reduction gear 56a meshes with the second small-diameter gear 58b. The third small-diameter gear 56b is provided coaxially with the third reduction gear 56a. The driven gear 63a is meshed with the second small-diameter gear 58b. The gear case 59 accommodates each gear. The configuration of the gear case 59 will be described in detail below.

The first reduction gear 57a and the first small-diameter gear 57b are integrally rotatably supported by the first support shaft 57c. The first reduction gear 57a, the first small-diameter gear 57b, and the first support shaft 57c constitute the first reduction shaft 57. The second reduction gear 58a and the second small-diameter gear 58b are integrally rotatably supported by the second support shaft 58c. The second reduction gear 58a, the second small-diameter gear 58b, and the second support shaft 58c constitute the second reduction shaft 58. The third reduction gear 56a and the third small-diameter gear 56b are integrally rotatably supported by the third support shaft 56c. The third reduction gear 56a, the third small-diameter gear 56b, and the third support shaft 56c constitute the third reduction shaft 56.

The third reduction shaft 56 is arranged in front of the second reduction shaft 58 and the second reduction shaft 58 is arranged in front of the first reduction shaft 57. The release shaft 53 is arranged in front of the third reduction shaft 56. The center axis C4 of the release shaft 53 and the center axes C1, C2, and C3 of the reduction shafts 56, 57, and 58 are arranged on the same straight line T1 extending in a forward/backward direction as seen in the axial direction. The axis arrangement of the clutch actuator 50 will be described in detail below.

The first support shaft 57c, the second support shaft 58c, and the third support shaft 56c are each rotatably supported by the gear case 59. The third reduction gear 56a is a fan-shaped gear centered on the third support shaft 56c. The third reduction gear 56a is provided to extend in front of the third support shaft 56c and outward in the vehicle width direction. In the drawings, the line C1 indicates the center axis of the first reduction shaft 57, the line C2 indicates the center axis of the second reduction shaft 58, and the line C3 indicates the center axis of the third reduction shaft 56.

The driven gear 63a is integrally rotatably provided on the release shaft 53. The driven gear 63a is a fan-shaped gear centered on the release shaft 53. The driven gear 63a is provided to extend in front of the release shaft 53 and inward in the vehicle width direction. A downstream gear in the deceleration mechanism 51 has a small rotation angle. For this reason, the third reduction gear 56a and the driven gear 63a can be fan-shaped gears having a small rotation angle.

As a result, the deceleration mechanism 51 and the clutch actuator 50 can be miniaturized. That is, even if a large-diameter reduction gear is provided to obtain a deceleration ratio, the following effects are achieved by notching a part other than the meshing range of the deceleration gear into a fan shape. That is, in particular, it is possible to suppress the overhang of the deceleration mechanism 51 outward in the vehicle width direction and it is possible to reduce the weight of the deceleration mechanism 51.

According to the configuration, the motor 52 and the release shaft 53 can constantly work together via the deceleration mechanism 51. Thereby, a system in which the clutch device 26 is directly connected and disconnected by the clutch actuator 50 is configured.

Each gear is a flattened spur gear with a suppressed axial thickness and the gear case 59 is also formed in a flattened shape with a suppressed axial thickness. Thereby, an increase in the axial thickness of the entire deceleration mechanism 51 is suppressed and it becomes difficult to stand out in the vehicle side view. Moreover, it is easier to stack and arrange the gears in the axial direction.

On the upper surface side of the gear case 59, the rotation angle sensor 56d is provided. The rotation angle sensor 56d is connected to one end portion of the third reduction shaft 56 to detect the rotation angle. By detecting the rotation angle of the third reduction shaft 56 close to the release shaft 53, the detection accuracy of the rotation angle of the release shaft 53 and the clutch capacity is increased.

The motor 52 is arranged to project downward from the front portion of the gear case 59. Thereby, the motor 52 can be arranged as follows. That is, a bulge portion 17b covering the clutch device 26 in the right cover 17a can be arranged away from the front. For this reason, the overhang of the clutch actuator 50 outward in the vehicle width direction is suppressed.

The drive force of the motor 52 is decelerated as follows and transmitted to the release shaft 53. That is, the drive force of the motor 52 is decelerated between the drive gear 55a and the first reduction gear 57a, decelerated between the first small-diameter gear 57b and the second reduction gear 58a, decelerated between the second small-diameter gear 58b and the third reduction gear 56a, and further decelerated between the third small-diameter gear 56b and the driven gear 63a.

### Arrangement of Clutch Actuator

As shown in FIG. 1, the clutch actuator 50 is arranged vertically below the knee grip part 18a on the right side of the fuel tank 18 in the vehicle side view. In FIG. 1, the thigh of the rider's leg is imaged as a line L1, the lower leg below the knee is imaged as a line L2, and the foot extending forward from the ankle is imaged as a line L3. The lower leg L2 extends as the rider's leg diagonally rearward and downward from the knee grip part 18a in the vehicle side view and the foot L3 is placed on the step 18b.

The clutch actuator 50 projects outward in the vehicle width direction from the knee grip part 18a. The clutch actuator 50 is arranged away from the front of the lower leg L2 of the rider's leg in the vehicle side view. Thereby, interference of the clutch actuator 50 for an arrangement space of the rider's legs is suppressed. The clutch actuator 50 is arranged away from the front of the lower leg L2 of the rider's leg in the vehicle side view even if the rider extends the leg and lands the foot L3. In this regard, the interference of the clutch actuator 50 for the arrangement space of the rider's legs is suppressed.

Referring also to FIGS. 13 to 15, the right cover 17a has the following range as the bulge portion 17b that bulges outward in the vehicle width direction. The above range is a circular range coaxial with the clutch device 26 in the vehicle side view. A cover recess portion 17c is formed in the upper portion of the bulge portion 17b. The cover recess portion 17c changes an outer side surface inward in the vehicle width direction with respect to the lower portion of the bulge portion 17b. The cover recess portion 17c forms a step portion 17d that changes the outer side surface of the bulge portion 17b in a stepped shape. The step portion 17d forms a plane in the vehicle width direction. The clutch actuator 50 is attached to the right cover 17a in a state in which the clutch actuator 50 is arranged to enter the cover recess portion 17c.

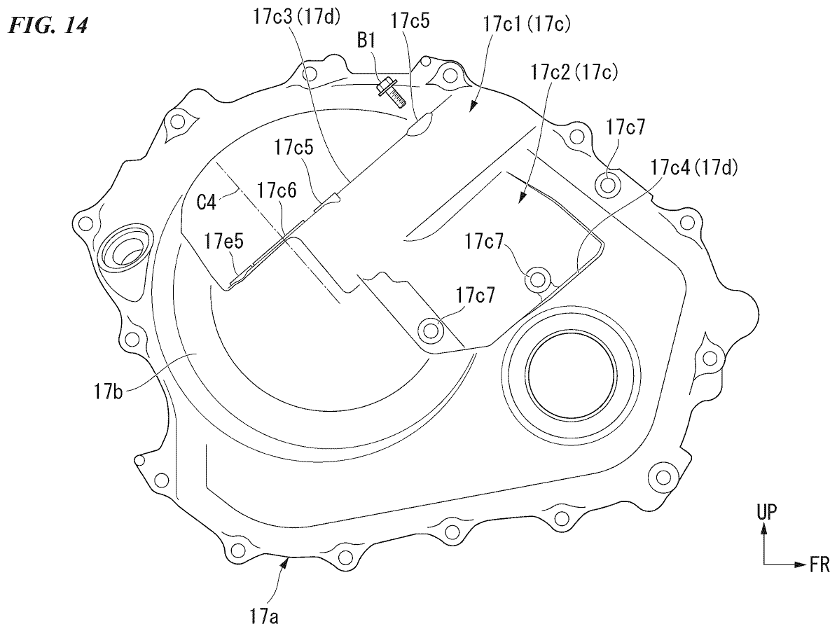

Referring to FIGS. 13 and 14, the cover recess portion 17c includes a first recess portion 17cl into which the gear case 59 of the clutch actuator 50 is inserted and a second recess portion 17c2 into which a motor case 66 is inserted. The cover recess portion 17c is formed so that the second recess portion 17c2 is shallower in the vehicle width direction than the first recess portion 17c1. The first recess portion 17cl and the second recess portion 17c2 are formed to be inclined according to the inclination of the vehicle side view of the clutch actuator 50. The second recess portion 17c2 projects to the vehicle front side of the bulge portion 17b. For illustrative convenience, the details of the right cover 17a differ between FIGS. 13 and 14.

The first recess portion 17c1 forms a first plane portion 17c3 along the lower surface of the upper-stage portion 68 (to be described in detail below) of the gear case 59. The second recess portion 17c2 forms a second plane portion 17c4 along the lower surface of a motor cover 67 (to be described in detail below) fixed to the lower portion of the clutch actuator 50. The first plane portion 17c3 and the second plane portion 17c4 are included in the step portion 17d. The first plane portion 17c3 and the second plane portion 17c4 form a plane shape orthogonal to the axial direction.

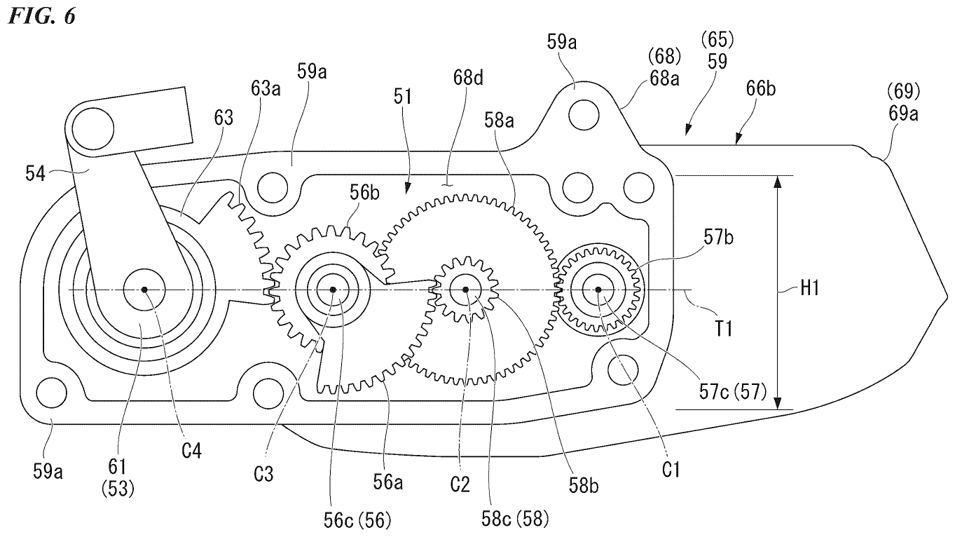

In the first plane portion 17c3, a plurality of upper fastening portions 17c5 for fastening the upper-stage portion 68 of the gear case 59 with a bolt B1 in the axial direction are formed and a shaft insertion portion 17c6 through which the release shaft 53 is inserted is formed. In the gear case 59, a plurality of case-side fastening portions 59a (see FIG. 6) fastened by inserting the bolt B1 are formed in correspondence with a plurality of upper fastening portions 17c5, and an opening 59 (see FIG. 5) through which the release shaft 53 is inserted is formed in correspondence with the shaft insertion portion 17c6. The upper portion of the release shaft 53 projects diagonally upward and backward from the first plane portion 17c3 to the inside of the gear case 59.

In the lower portion of the second recess portion 17c2, a plurality of lower fastening portions 17c7 for fastening the motor cover 67 with a bolt B2 in the vehicle width direction (a direction orthogonal to the axial direction) (for example, three locations) are formed. In the motor cover 67, a plurality of cover-side fastening portions 67a fastened by inserting the bolt B2 are formed in correspondence with a plurality of lower fastening portions 17c7. A bolt hole 67b through which the bolt B2 is inserted in each cover-side fastening portion 67a has an elliptical shape that is long in the axial direction. Thereby, axial tolerances can be absorbed when the lower portion of the clutch actuator 50 is fastened. That is, the axial position of the clutch actuator 50 is determined by the fact that the upper fixing portion (the case-side fastening portion 59a) is axially in contact with the first plane portion 17c3, but the bolt hole 67b that is long in the axial direction can absorb positional deviation of the lower portion of the clutch actuator 50 due to axial component tolerances and the like in the fixing portion (the cover-side fastening portion 67a) of the lower portion of the clutch actuator 50.

### Release Shaft

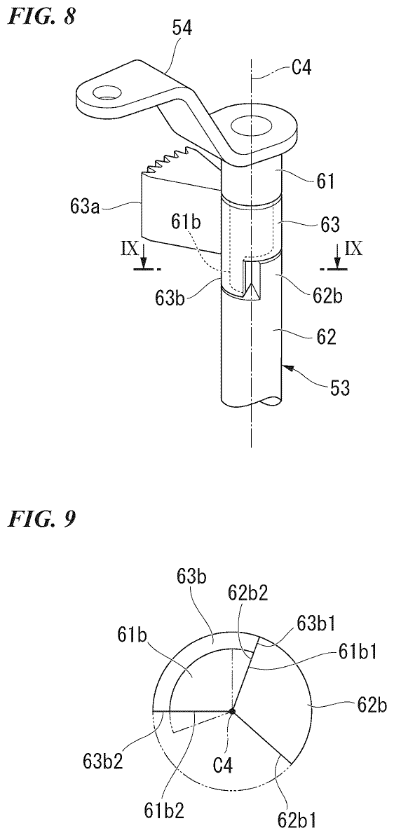

As shown in FIGS. 5, 8, and 9, the release shaft 53 is divided into a plurality of elements to individually receive an input from the clutch actuator 50 and an input from the manipulation of the occupant so that rotation is possible.

The release shaft 53 includes an upper release shaft 61 constituting the upper portion, a lower release shaft 62 constituting the lower portion, and an intermediate release shaft 63. The intermediate release shaft 63 straddling the lower end portion of the upper release shaft 61 and the upper end portion of the lower release shaft 62 is arranged.

The upper release shaft 61 has a cylindrical shape. The upper release shaft 61 is rotatably supported by an upper boss portion 59b of the gear case 59. The upper release shaft 61 has an upper end portion projecting outside the gear case 59. The driven clutch lever 54 is integrally rotatably supported on the upper end portion of the upper release shaft 61. A return spring (not shown) is attached to the driven clutch lever 54. This return spring applies a biasing force of a direction opposite to that of the rotation based on the manipulation of the clutch manipulation element (the rotation in the clutch disconnection direction) to the driven clutch lever 54.

The lower release shaft 62 has a cylindrical shape. The lower release shaft 62 has a lower portion rotatably supported inside the right cover 17a. The lower portion of the lower release shaft 62 faces the inside of the gear case 59. In the lower portion, the eccentric cam portion 38a of the release mechanism 38 is formed (see FIG. 2). A lower return spring (not shown) is attached to the lower end portion of the lower release shaft 62. The lower return spring applies a biasing force in an opposite direction to the rotation in the clutch disconnection direction to the lower release shaft 62.

A manual-manipulation-side cam 61b extending in the axial direction in a cross-sectional fan shape is provided on the lower end portion of the upper release shaft 61.

The clutch-side cam 62b extending in the axial direction in a cross-sectional fan shape is provided on the upper end portion of the lower release shaft 62. The clutch-side cam 62b is provided in a range in which the manual-manipulation-side cam 61b is avoided in the circumferential direction.

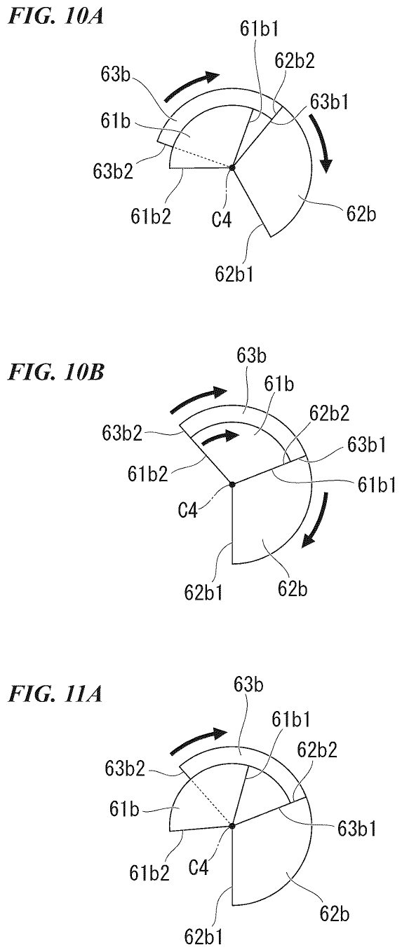

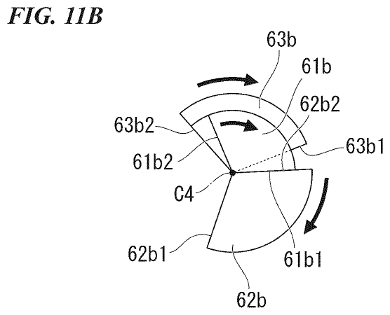

The lower end portion of the upper release shaft 61 (the manual-manipulation-side cam 61b) and the upper end portion of the lower release shaft 62 (the clutch-side cam 62b) are away from each other in a circumferential direction and wrap the axial position. Thereby, it is possible to press the other circumferential side surface 62b2 of the clutch-side cam 62b with one circumferential side surface 61b1 of the manual-manipulation-side cam 61b and rotate the lower release shaft 62 (see FIGS. 10B and 11B).

The other circumferential side surface 61b2 of the manual-manipulation-side cam 61b and the one circumferential side surface 62b1 of the clutch-side cam 62b are spaced apart from each other in the circumferential direction. Thereby, when there is an input from the clutch actuator 50 to the clutch-side cam 62b, it is possible to rotate the lower release shaft 62 independently of the upper release shaft 61 (see FIGS. 10A and 11A).

The intermediate release shaft 63 is, for example, cylindrical. The intermediate release shaft 63 can be inserted through an engagement portion (an upper/lower shaft engagement portion) of the lower end portion of the upper release shaft 61 and the upper end portion of the lower release shaft 62. In the intermediate release shaft 63, the driven gear 63a is integrally rotatably supported.

A control-manipulation-side cam 63b extending in the axial direction in a cross-sectional fan shape is provided on the intermediate release shaft 63.

The intermediate release shaft 63 and the driven gear 63a suppress contact with other components of the clutch actuator 50. Specifically, the intermediate release shaft 63 only causes an inner circumferential portion to be in contact with the following portion in addition to a bearing supported on the gear case 59. The portion is the lower end portion of the upper release shaft 61 (the manual-manipulation-side cam 61b) and the upper end portion of the lower release shaft 62 (the clutch-side cam 62b).

Moreover, the driven gear 63a only causes the gear teeth to be in contact with the second small-diameter gear 58b. Thereby, the friction of the driven gear 63a, which is a control gear, is reduced as much as possible, and the accuracy of the control of the release shaft 53 is improved.

The control-manipulation-side cam 63b of the intermediate release shaft 63 and the clutch-side cam 62b of the lower release shaft 62 are away from each other in the circumferential direction and wrap the axial position. Thereby, it is possible to press the other circumferential side surface 62b2 of the clutch-side cam 62b with the one circumferential side surface 63b1 of the control-manipulation-side cam 63b and rotate the lower release shaft 62.

Moreover, the control-manipulation-side cam 63b is arranged to avoid the manual-manipulation-side cam 61b of the upper release shaft 61 in a radial direction. Thereby, when the input from the clutch actuator 50 is transmitted to the clutch-side cam 62b, the lower release shaft 62 can be rotated independently of the upper release shaft 61. Moreover, when there is a manual manipulation, the upper release shaft 61 can be rotated independently from the intermediate release shaft 63 on the control side.

The other circumferential side surface 63b2 of the control-manipulation-side cam 63b and the one circumferential side surface 62b1 of the clutch-side cam 62b are spaced apart from each other in the circumferential direction. Thereby, when there is an input from the control-manipulation-side cam 63b to the clutch-side cam 62b, the lower release shaft 62 can be rotated independently of the intermediate release shaft 63.

Referring to FIG. 5, the clutch actuator 50 rotatably holds the upper release shaft 61 and the intermediate release shaft 63 in the gear case 59. The clutch actuator 50 includes the upper release shaft 61 and the intermediate release shaft 63. The lower release shaft 62 is rotatably held on the right cover 17a.

Referring also to FIG. 14, a shaft insertion portion 17c5 is provided in the first plane portion 17c3 of the step portion 17d of the cover recess portion 17c of the right cover 17a and the upper end portion of the lower release shaft 62 is projected. An opening 59c is provided in a portion facing the first plane portion 17c3 of the step portion 17d of the cover recess portion 17c in the gear case 59 and the upper end portion of the lower release shaft 62 projecting from the shaft insertion portion 17c5 is allowed to face the inside of the gear case 59.

In such a configuration, when the clutch actuator 50 is attached to the right cover 17a, the release shaft 53 that is linear is configured together with the lower release shaft 62 on a right cover 17a side. The release shaft 53 is configured by interconnecting the upper release shaft 61, the intermediate release shaft 63, and the lower release shaft 62.

The power unit PU of the embodiment can be configured as follows for a manual clutch type power unit in which the disconnection/connection manipulation of the clutch device 26 is performed according to the manipulation of the rider without performing any electrical control. That is, the power unit PU can be configured by replacing the right cover 17a and the release shaft 53 and retrofitting the clutch actuator 50. For this reason, the clutch actuator 50 can be attached to a power unit of a different model. For this reason, the clutch actuator 50 can be shared by multiple models to easily configure a semi-automatic transmission system (an automatic clutch type transmission system).

### Motor Control

Referring to FIG. 5, a configuration in which the two motors 521 and 522 in the clutch actuator 50 may work together to drive the release shaft 53 (or disconnect and connect the clutch device 26) may be adopted in the embodiment. In this case, the motors 521 and 522 can be miniaturized by halving the load shared by the two motors 521 and 522. Thereby, the degree of freedom in the layout of the motor 52 increases compared to a case where a large single motor 52 is provided. For this reason, even if the clutch actuator 50 is arranged in an outer-side portion of the power unit PU, it is easy to suppress the overhang of the clutch actuator 50 outward in the vehicle width direction. Therefore, it is possible to substantially reduce the size of the clutch control device 40A.

In the embodiment, in the clutch actuator 50, one of the plurality of (two) motors 52 may be used as a drive source for the release shaft 53 during normal (non-fail) times, and the remaining one may be used for another purpose. For example, the remaining motor 52 may refrain from actuating for fail-safe or may be used as an electric current sensor.

### Shaft Arrangement of Clutch Actuator

Next, the arrangement of the drive shaft 55 of the motor 52 in the clutch actuator 50, the release shaft 53, and the reduction shafts 56, 57, and 58 of the deceleration mechanism 51 will be described.

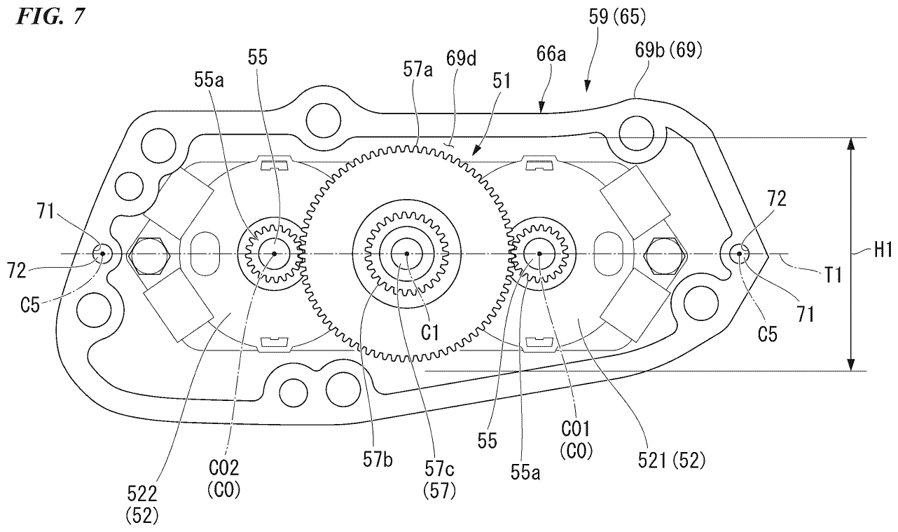

Referring to FIGS. 5 to 7 and 13, the following center axis extending in the vertical direction in the clutch actuator 50 is inclined to be located on the rear side in the proximity of the upper side in the vertical direction in the vehicle side view (as only indicated by C4 in FIG. 13). The center axes are the center axis C4 of the release shaft 53, the center axis CO of the motor 52 (the center axes C01 and C02 of each motor 521 and 522), and the center axes C1, C2, and C3 of the support shafts 56c, 57c, and 58c of the reduction shafts 56, 57, and 58 of the deceleration mechanism 51. These center axes are parallel to each other in the vehicle side view and arranged on the same straight line T1 as seen in the axial direction (see FIGS. 6 and 7).

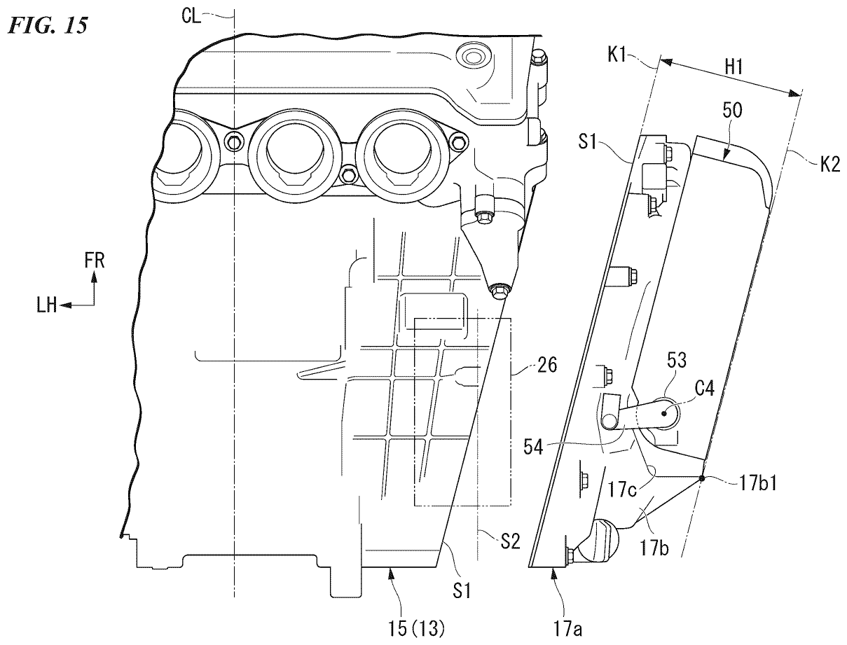

Referring to FIG. 15, in the vehicle top view, the joint surface S1 between the right side portion of the crankcase 15 (which is also the main body part of the clutch case accommodating the clutch device 26) and the right cover 17a is inclined in the forward/backward direction with respect to the plane S2 orthogonal to the vehicle width direction. Specifically, the joint surface S1 is inclined to be located inward in the vehicle width direction in the proximity of the rear side. Thereby, the overhang on the rear right side of the crankcase 15 is suppressed and an increase in the size of the crankcase 15 at the time of molding is suppressed. The straight line T1 is substantially parallel to the joint surface S1 in a vehicle top view (generally axial view) (for example, it means that they do not intersect each other within the front and rear lengths of the vehicle). The right side portion of the crankcase 15 and the right cover 17a constitute a clutch case that accommodates the clutch device 26.

In the vehicle top view, the clutch actuator 50 is arranged to fit between the first virtual line K1 along the joint surface S1 and the second virtual line K2 parallel to the first virtual line K1 and passing through the outer side end 17b1 of the bulge portion 17b of the right cover 17a in the vehicle width direction. In the drawing, reference sign H2 denotes a width between the first virtual line K1 and the second virtual line K2.

The clutch actuator 50 has a flat shape in which increases in the left and right widths in the width direction orthogonal to the straight line T1 direction and the axial direction are suppressed with respect to the front and rear widths in the straight line T1 direction and the vertical width in the axial direction. The clutch actuator 50 suppresses the overhang outward in the vehicle width direction by directing the width direction approximately in the vehicle width direction. The clutch actuator 50 increases the overhang outward in the vehicle width direction in the proximity of the front side when the straight line T1 direction (the arrangement direction of each axis) is inclined outward in the vehicle width direction in the proximity of the front side. The front-side overhang of the clutch actuator 50 is away from the arrangement space of the rider's legs (see FIG. 1) and interference of the clutch actuator 50 to the rider's legs is suppressed.

### Unit Case Structure

Next, a structure of the unit case 65 of the clutch actuator 50 will be described. Referring to FIGS. 5 and 13, the unit case 65 includes the gear case 59, the motor case 66, and the motor cover 67.

The gear case 59 is formed to form two upper and lower stages in the axial direction. Hereinafter, the upper portion of the gear case 59 is referred to as an upper-stage portion 68 and the lower portion of the gear case 59 is referred to as a lower-stage portion 69. The gear case 59 has an aspect in which the upper-stage portion 68 is shifted backward along a plane orthogonal to the lower-stage portion 69 in the axial direction. Below the lower-stage portion 69, the motor case 66 extending in the axial direction is connected. The motor cover 67 is fixed to the lower portion of the motor case 66.

The upper-stage portion 68 of the gear case 59 is vertically divided by the border of a dividing surface orthogonal to the axial direction. Hereinafter, the lower portion of the upper-stage portion 68 is referred to as an upper-stage portion body 68a that is open upward and the upper portion of the upper-stage portion 68 is referred to as an upper case cover 68b that closes an upper opening of the upper-stage portion body 68a from above. The lower-stage portion 69 of the gear case 59 is vertically divided by the border of a dividing surface orthogonal to the axial direction. Hereinafter, the upper portion of the lower-stage portion 69 is referred to as a lower-stage portion body 69a that is open downward and the lower portion of the lower-stage portion 69 is referred to as a lower case cover 69b that closes the lower portion of the lower-stage portion body 69a from below.

The upper-stage portion 68 has a rectangular shape that is long in the direction along the straight line T1 (the straight line T1 direction) in an axial view. The lower-stage portion 69 has an elliptical shape that is long in the straight line T1 direction in the axial view. The upper-stage portion 68 forms an upper-stage gear accommodation chamber 68d and the lower-stage portion 69 forms a lower-stage gear accommodation chamber 69d. The upper-and lower-stage gear accommodation chambers 68d and 69d are separated by a partition wall.

The motor case 66 forms a motor accommodation chamber 66d that accommodates the two motors 52. The motor accommodation chamber 66d accommodates the two motors 52 that are cylindrical in parallel. The motor case 66 is shaped like a cylinder with a bottom and an elliptical cross section. In the upper portion of the motor case 66, the lower case cover 69b is integrally formed to expand the cross-sectional shape.

The motor case 66 and the lower case cover 69b are integrally formed with each other to constitute the lower case body 66a (the first case). The upper-stage portion body 68a and the lower end body are integrally formed with each other to constitute the upper case body 66b (the second case).

The lower case body 66a forms the motor accommodation chamber 66d that accommodates the two motors 52 and the upper case body 66b forms the gear accommodation chambers 68d and 69d that accommodate the deceleration mechanism 51. The upper case body 66b is attached to the upper case cover 68b from above and forms the upper-stage gear accommodation chamber 68d with the upper case cover 68b. The upper case body 66b is attached to the lower case cover 69b of the lower case body 66a from below and forms the lower-stage gear accommodation chamber 69d (the second gear accommodation chamber) with the lower case cover 69b.

As seen in the axial direction, each gear of the deceleration mechanism 51 is partially coupled with a fan-shaped gear to suppress an increase in the width in the direction orthogonal to the straight line T1. Each gear of the deceleration mechanism 51 is arranged within the width H1 of the motor case 66 in the lower case body 66a in a direction orthogonal to the straight line T1.

The drive gear 55a of the drive shaft 55 of each of the two motors 52 projects into the lower-stage gear accommodation chamber 69d. The first reduction gear 57a which is a single input gear of the deceleration mechanism 51 is arranged between the two drive gears 55a in the straight line T1 direction. The first reduction gear 57a having both ends in the straight line T1 direction is meshed with the two drive gears 55a.

The first reduction gear 57a is supported by the first support shaft 57c (the input shaft). The first support shaft 57c is held in the upper case body 66b, and one side (the lower side) in the axial direction projects into the second gear accommodation chamber 69d. The first reduction gear 57a is supported by a projection portion of the first support shaft 57c into the second gear accommodation chamber 69d. The projecting portion of the first support shaft 57c is cantilevered on the upper case body 66b side and is not supported on the lower case body 66a. Thereby, a bearing for supporting the first support shaft 57c is not required between the two motors 52 in the lower case body 66a. Therefore, it is possible to make the two motors 52 as close to each other as possible, and to reduce the size of the clutch actuator 50 as much as possible in the straight line T1 direction (the arrangement direction of each axis).

The motor cover 67 is fixed to the lower portion of the motor case 66 of the lower case body 66a. The motor cover 67 is a fixing member for fixing the motor case 66 and the lower portion of the clutch actuator 50 to the right cover 17a.

Referring to FIGS. 5 and 7 together, the lower case body 66a and the upper case body 66b are mutually positioned via a pair of front and rear knock pins 71. The pair of front and rear knock pins 71 are arranged outside the two drive shafts 55 in the straight line T1 direction to gain a pitch therebetween. In the drawings, the line C5 indicates the center axis of the knock pin 71. The pair of front and rear knock pins 71 are arranged so that each axial center (the axis C5) is located on the straight line T1 as seen in the axial direction. The pair of front and rear knock pins 71 perform mutual positioning of the lower case body 66a and the upper case body 66b in a direction orthogonal to the axial direction.

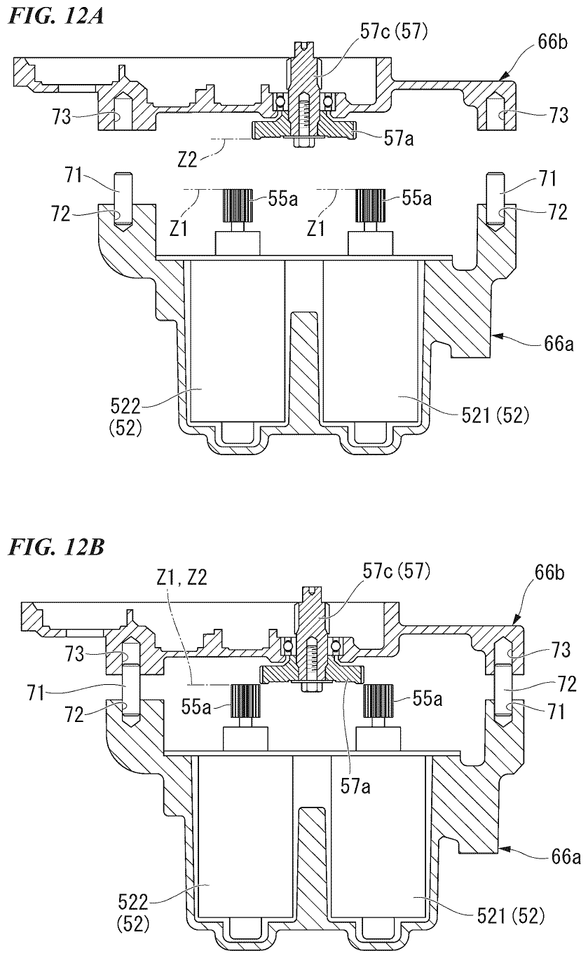

Further referring to FIG. 12A, each knock pin 71, for example, is held by fitting the lower portion into the holding hole 72 of the lower case body 66a. In the upper case body 66b, a pair of front and rear fitting holes 73 into which the knock pins 71 are inserted are formed.

Referring to FIG. 5, an insertion depth D1 into each fitting hole 73 of each knock pin 71 is set to be deeper than an axial meshing depth D2 between each drive gear 55a and the first reduction gear 57a. The “meshing depth D2” corresponds to an amount of axial movement from a state in which the lower case body 66a and the upper case body 66b are disassembled and an upper end height Z1 of each drive gear 55a is consistent with a lower end height Z2 of the first reduction gear 57a (see FIG. 12B) to a state in which the lower case body 66a and the upper case body 66b are coupled and each drive gear 55a and the first reduction gear 57a mesh (see FIG. 5).

When the clutch actuator 50 is assembled, first, each gear of the deceleration mechanism 51, each motor 52, and the like are assembled in advance on the lower case body 66a and the upper case body 66b. Subsequently, the lower case body 66a and the upper case body 66b are coupled in the proximity of each other in the axial direction.

At this time, as shown in FIG. 12B, before each drive gear 55a and the first reduction gear 57a mesh, the lower case body 66a and the upper case body 66b are positioned in a direction orthogonal to the axial direction by the knock pin 71. That is, before each drive gear 55a and the first reduction gear 57a mesh, the knock pin 71 enters the fitting hole 73. Thereby, before each drive gear 55a and the first reduction gear 57a mesh, they are mutually positioned in a direction orthogonal to the axial direction.

Thereafter, after the upper end height Z1 of each drive gear 55a is consistent with the lower end height Z2 of the first reduction gear 57a, if there is no interference between the teeth of each gear, the lower case body 66a and the upper case body 66b can be brought close in the axial direction to couple them as they are. When the teeth of the gears interfere with each other, for example, the first reduction gear 57a turns using a jig, a tool, or the like and the interference between the teeth of the gears is eliminated.

Thereby, even if the first reduction gear 57a is not supported by the lower case body 66a like the drive gear 55a, when the lower case body 66a and the upper case body 66b are coupled, the first reduction gear 57a and the drive gear 55a can easily mesh. In addition, each knock pin 71 may be configured to be held in the upper case body 66b. Moreover, one knock pin 71 may be configured to be held in the upper case body 66b and the other knock pin 71 may be configured to be held in the lower case body 66a.

As described above, the clutch control device 40A in the above-described embodiment includes the clutch device 26 configured to disconnect and connect motive power transmission between a prime mover (the engine 13) and an output target (the transmission 21) of a machine (the two-wheeled motor vehicle 1); and the clutch actuator 50 configured to output a drive force for actuating the clutch device 26, wherein the clutch actuator 50 includes the electric motor 52 serving as a drive source, the release shaft 53 configured to rotate in response to an input from the electric motor 52, and a reduction gear mechanism (the deceleration mechanism 51) configured to establish a connection between the electric motor 52 and the release shaft 53, and wherein a drive shaft 55 of the electric motor 52, the release shaft 53, and center shafts 56c, 57c, and 58c of gears of the deceleration mechanism 51 are parallel to each other in an axial direction and axial centers (the axes C0, C1, C2, C3, and C4) are arranged on the same straight line T1 as seen in the axial direction.

According to this configuration, the axes of the motor 52, the release shaft 53, and the reduction gear mechanism 51 of the clutch actuator 50 are mutually arranged on the same straight line T1, such that it is possible to suppress an increase in a width of the clutch actuator 50 in a direction (approximately a vehicle width direction) orthogonal to an arrangement direction of the motor 52, the release shaft 53, and the deceleration mechanism 51 (approximately a forward/rearward direction of the vehicle). Thus, when a direction orthogonal to the arrangement direction of the motor 52, the release shaft 53, and the reduction gear mechanism 51 is a width direction of the machine (the two-wheeled motor vehicle 1), an increase in an amount of overhang of the clutch actuator 50 in the width direction of the machine can be suppressed and the machine including the clutch actuator 50 can be miniaturized.

Moreover, in the above-described clutch control device 40A, the plurality of motors 52 (the first motor 521 and the second motor 522) are provided and the drive shafts 55 of the motors 521 and 522 are parallel to each other in the axial direction and axial centers (the axes C01 and C02) are arranged on the straight line T1 as seen in the axial direction, wherein the clutch actuator 50 includes the lower case body 66a configured to form the motor accommodation chamber 66d configured to accommodate the plurality of motors 52, and the upper case body 66b configured to form the gear accommodation chambers 68d and 69d configured to accommodate the deceleration mechanism 51, wherein the gear accommodation chambers 68d and 69d include the first gear accommodation chamber 68d formed on an opposite side of the lower case body 66a in the axial direction and the second gear accommodation chamber 69d formed on the lower case body 66a side in the axial direction, wherein the drive gear 55a projecting into the second gear accommodation chamber 69d is provided on the drive shaft 55 of each of the plurality of electric motors 52, wherein the deceleration mechanism 51 includes a single first reduction gear 57a arranged between the two or more drive gears 55a in the second gear accommodation chamber 69d and configured to mesh with the two or more drive gears 55a, and the first support shaft 57c held in the upper case body 66b and configured to project the one side of the axial direction into the second gear accommodation chamber 69d and support the first reduction gear 57a on the one side of the axial direction, wherein the first support shaft 57c that is the center shaft of the first reduction gear 57a and the plurality of drive shafts 55 have axial centers (the axes C1, C01, and C02) arranged on the straight line T1 as seen in the axial direction, wherein the lower case body 66a and the upper case body 66b are mutually positioned via the plurality of knock pins 71 arranged on outer sides of the plurality of drive shafts 55 in the arrangement direction, and wherein the plurality of knock pins 71 have axial centers (the axes C5) arranged on the straight line T1 as seen in the axial direction.

According to this configuration, even in a configuration in which the single first reduction gear 57a supported by the upper case body 66b is meshed with the drive gears 55a of the plurality of motors 52 accommodated in the lower case body 66a, the lower case body 66a and the upper case body 66b are positioned by arranging the plurality of knock pins 71 on outer sides of the plurality of drive shafts 55 on the straight line T1 on which the plurality of drive gears 55a and the single first reduction gear 57a are arranged. Thereby, a sufficient pitch between the knock pins 71 can be obtained and the plurality of drive gears 55a can be meshed with the single first reduction gear 57a with high accuracy. Moreover, the overhang of each configuration of the clutch actuator 50 in a direction orthogonal to the straight line T1 (in the machine width direction) can be suppressed and the machine including the clutch actuator 50 can be miniaturized.

Moreover, in the above-described clutch control device 40A, each of the plurality of knock pins 71 is held in one of the lower case body 66a and the upper case body 66b and the plurality of fitting holes 73 into which the knock pins corresponding thereto are inserted are formed in the other of the lower case body 66a and the upper case body 66b, and the insertion depth D1 for the fitting hole 73 corresponding to each knock pin 71 is deeper than the meshing depth D2 of each drive gear 55a and the first reduction gear 57a in the axial direction.

According to this configuration, when the clutch actuator 50 is assembled, if the lower case body 66a and the upper case body 66b are made close to each other in the axial direction, the knock pin 71 is fitted into the fitting hole 73 before the drive gear 55a and the first reduction gear 57a are meshed. Thereby, the drive gear 55a and the first reduction gear 57a can be meshed in the axial direction while the relative positions of the lower case body 66a and the upper case body 66b (and the relative positions of the drive gear 55a and the first reduction gear 57a) are accurately determined, and the assembly of the actuator 50 can be facilitated.

Moreover, in the above-described clutch control device 40A, in a direction orthogonal to the straight line T1 as seen in the axial direction, each gear of the deceleration mechanism 51 is arranged within the width H1 of the motor case 66 forming the motor accommodation chamber 66d in the lower case body 66a.

According to this configuration, an increase in the size of each gear of the deceleration mechanism 51 is suppressed, such that the overhang of the clutch actuator 50 can be suppressed in the direction orthogonal to the arrangement direction of the motor 52 and the deceleration mechanism 51 and the machine including the clutch actuator 50 can be miniaturized.

Moreover, the clutch control device 40A includes the motor cover 67 fixed to the motor case 66 forming the motor accommodation chamber 66d in the lower case body 66a, wherein the motor cover 67 includes the cover-side fastening portion 67a fastened to a machine-side portion (the right cover 17a) in a direction orthogonal to the axial direction, and wherein the cover-side fastening portion 67a forms the bolt insertion hole 67b having an elliptical shape that is long in the axial direction.

According to this configuration, because the motor cover 67 fixed to the motor case 66 of the lower case body 66a is fastened using a long hole that is long in the axial direction with respect to the machine-side portion, it is possible to attach the motor case 66 to the machine-side portion while absorbing the part tolerance in the axial direction. The “machine-side portion” is a general term for a part fixed to a machine body side except for the clutch actuator 50.

Moreover, the clutch control device 40A includes the right cover 17a attached to the clutch case (the crankcase 15) and configured to cover the clutch device 26 from one side of the machine in a width direction, wherein the joint surface S1 between the right cover 17a and the clutch case is inclined with respect to the plane S2 orthogonal to the width direction in a machine top view, and wherein, in the top view, the clutch actuator 50 is arranged to fit between the first virtual line K1 along the joint surface S1 and the second virtual line K2 parallel to the first virtual line K1 and passing through the outer side end 17b1 of the right cover 17a in the width direction.

According to this configuration, an increase in the amount of overhang of the machine in the width direction can be suppressed and an increase in the width of the small assembly between the clutch actuator 50 and the right cover 17a can be suppressed.

The present invention is not limited to the above embodiments. For example, the clutch manipulation element is not limited to the clutch lever, but may be a clutch pedal or any of various other manipulation elements. The clutch device may be a normally open clutch that is in a disconnected state at normal times without any external input. The clutch device is not limited to one arranged between the engine and the transmission, but may be arranged between the prime mover and any output target other than the transmission. The prime mover may be an electric motor as well as an internal combustion engine.

The release mechanism 38 is not limited to a type in which the lifter shaft 39 is pulled to the right, but may be a type in which the lifter shaft 39 is pushed to the right or left.

As in the above embodiment, it is not limited to application to a saddle-riding vehicle in which the clutch manipulation is automated. For example, it can be applied to a saddle-riding vehicle (a saddle-riding vehicle equipped with a transmission device without any clutch manipulation) that can change gears by adjusting the drive force without any manual clutch manipulation under predetermined conditions, while basically using a manual clutch manipulation.

The clutch control device of the present embodiment may be applied to saddle-riding vehicles other than the two-wheeled motor vehicle.

The above-mentioned saddle-riding vehicles include all vehicles that the rider rides across the vehicle body, and include not only two-wheeled motor vehicles (including motorized bicycles and scooter-type vehicles) but also three-wheeled vehicles (including vehicles with two front wheels and one rear wheel in addition to vehicles with one front wheel and two rear wheels) or four-wheeled vehicles (such as four-wheeled buggies).

The present invention may be applied to vehicles that include an electric motor as a prime mover.

The present invention may be applied to vehicles other than saddle-riding vehicles (passenger cars, buses, trucks, and the like).

Although the clutch actuator 50 is arranged to avoid the space for the rider's legs in the present embodiment, the present invention is not limited to this configuration.

For example, the clutch control device of the present embodiment can also be applied to cruiser-type vehicles in which the step on which the rider's feet rest is located toward the front of the vehicle. The clutch control device of the present embodiment suppresses an increase in the amount of overhang of the clutch actuator in a machine width direction and miniaturizes a machine including the clutch actuator. In addition to the suppression of an increase in an amount of contact with the rider's foot, effects such as weight reduction and miniaturization, non-obstruction (hard to ground) at bank time, the reduction of air resistance due to the reduction of a front projection area, and the like can be obtained.

Although the clutch control device of the present embodiment is applied to a vehicle, the present invention is not limited to the application to a vehicle and may be applied to various types of transportation machines such as an aircraft and a watercraft, various types of vehicles such as construction machinery and industrial machinery, and mobile objects. Furthermore, the present invention is widely applicable to any machine including the clutch control device, for example, hand-pushed lawn mowers, cleaning machines, and the like, in addition to the vehicles.

The configuration in the above-described embodiment is an example of the present invention. In a process of replacing the constituent elements of the embodiment with well-known constituent elements and the like, various changes can be made without departing from the scope and spirit of the present invention.

### BRIEF DESCRIPTION OF THE REFERENCE SYMBOLS

1 Two-wheeled motor vehicle (machine)
13 Engine (internal combustion engine, prime mover)
15 Crankcase (clutch case)
17a Right cover (machine cover)
17b1 Outer side end
21 Transmission (output target)
26 Clutch device
40A Clutch control device
50 Clutch actuator
51 Deceleration mechanism (reduction gear mechanism)
52 Electric motor
521 First motor (electric motor)
522 Second motor (electric motor)
53 Release shaft
55 Drive shaft
55a Drive gear
56c Third support shaft (center shaft)
57a First reduction gear (input gear)
57c First support shaft (center shaft, input shaft)
58c Second support shaft (center shaft)
66 Motor case (accommodation portion)
66a Lower case body (first case)
66b Upper case body (second case)
66d Motor accommodation chamber (electric motor accommodation chamber)
67 Motor cover (fixing member)
68d Upper-stage gear accommodation chamber (first gear accommodation chamber)
69d Lower-stage gear accommodation chamber (second gear accommodation chamber)
71 Knock pin
73 Fitting hole
C0, C01, C02, C1, C2, C3, C4, C5 Center axis
D1 Insertion depth
D2 Meshing depth
H1 Width
K1 First virtual line
K2 Second virtual line
T1 Straight line
S1 Joint surface
S2 Horizontally orthogonal plane

What is claim is:

1.-9. (canceled)

10. A clutch control device comprising:
a clutch device configured to disconnect and connect motive power transmission between a prime mover and an output target of a machine; and
a clutch actuator configured to output a drive force for actuating the clutch device,
wherein the clutch actuator includes an electric motor serving as a drive source, a release shaft configured to rotate in response to an input from the electric motor, and a reduction gear mechanism configured to establish a connection between the electric motor and the release shaft,
wherein a drive shaft of the electric motor, the release shaft, and center shafts of gears of the reduction gear mechanism are parallel to each other in an axial direction and axial centers are arranged on the same straight line as seen in the axial direction,
wherein a plurality of electric motors are provided and drive shafts of the electric motors are parallel to each other in the axial direction and axial centers are arranged on the straight line as seen in the axial direction,
wherein the clutch actuator includes
a first case configured to form an electric motor accommodation chamber configured to accommodate the plurality of electric motors and
a second case configured to form gear accommodation chambers configured to accommodate the reduction gear mechanism,
wherein the gear accommodation chambers include a first gear accommodation chamber formed on an opposite side of the first case in the axial direction and a second gear accommodation chamber formed on a first case side in the axial direction, wherein a drive gear projecting into the second gear accommodation chamber is provided on the drive shaft of each of the plurality of electric motors,
wherein the reduction gear mechanism includes
a single input gear arranged between two or more drive gears in the second gear accommodation chamber and configured to mesh with the two or more drive gears, and
an input shaft held in the second case and configured to have one side in the axial direction projecting into the second gear accommodation chamber and support the input gear on the one side in the axial direction,
wherein the input shaft that is the center shaft of the input gear and a plurality of drive shafts have axial centers arranged on the straight line as seen in the axial direction,
wherein the first case and the second case are mutually positioned via a plurality of knock pins arranged on outer sides of the plurality of drive shafts, and
wherein the plurality of knock pins have axial centers arranged on the straight line as seen in the axial direction.

11. The clutch control device according to claim 10,
wherein each of the plurality of knock pins is held in one of the first case and the second case and a plurality of fitting holes into which the knock pins corresponding thereto are inserted are formed in the other of the first case and the second case, and
wherein an insertion depth of each knock pin into a corresponding fitting hole is deeper than a meshing depth of each drive gear and the input gear in the axial direction.

12. The clutch control device according to claim 10, wherein, in a direction orthogonal to the straight line as seen in the axial direction, each gear of the reduction gear mechanism is arranged within a width of an accommodation portion forming the electric motor accommodation chamber in the first case.

13. The clutch control device according to claim 11, wherein, in a direction orthogonal to the straight line as seen in the axial direction, each gear of the reduction gear mechanism is arranged within a width of an accommodation portion forming the electric motor accommodation chamber in the first case.

14. The clutch control device according to claim 10, further comprising a fixing member fixed to the accommodation portion forming the electric motor accommodation chamber in the first case,
wherein the fixing member includes a fastening portion fastened to a machine-side portion in a direction orthogonal to the axial direction, and
wherein the fastening portion forms a bolt insertion hole having an elliptical shape that is long in the axial direction.

15. The clutch control device according to claim 11, further comprising a fixing member fixed to the accommodation portion forming the electric motor accommodation chamber in the first case,
wherein the fixing member includes a fastening portion fastened to a machine-side portion in a direction orthogonal to the axial direction, and
wherein the fastening portion forms a bolt insertion hole having an elliptical shape that is long in the axial direction.

16. A clutch control device comprising:
a clutch device configured to disconnect and connect motive power transmission between a prime mover and an output target of a machine; and
a clutch actuator configured to output a drive force for actuating the clutch device,
wherein the clutch actuator includes an electric motor serving as a drive source, a release shaft configured to rotate in response to an input from the electric motor, and a reduction gear mechanism configured to establish a connection between the electric motor and the release shaft,
wherein a drive shaft of the electric motor, the release shaft, and center shafts of gears of the reduction gear mechanism are parallel to each other in an axial direction and axial centers are arranged on the same straight line as seen in the axial direction,
wherein the clutch control device further comprises a machine cover attached to the clutch case and configured to cover the clutch device from one side of the machine in a width direction,
wherein a joint surface between the machine cover and the clutch case is inclined with respect to a plane orthogonal to the width direction in a top view of the machine, and
wherein, in the top view, the clutch actuator is arranged to fit between a first virtual line along the joint surface and a second virtual line parallel to the first virtual line and passing through an outer side end of the machine cover in the width direction.

17. The clutch control device according to claim 16,
wherein each of a plurality of knock pins is held in one of a first case and a second case,
wherein a plurality of fitting holes into which the knock pins corresponding thereto are inserted are formed in the other of the first case and the second case, and
wherein an insertion depth for the fitting hole corresponding to each of the knock pin is deeper than a meshing depth of each drive gear and an input gear in the axial direction.

18. The clutch control device according to claim 16,
wherein, in a direction orthogonal to the straight line as seen in the axial direction, each gear of the reduction gear mechanism is arranged within a width of an accommodation portion forming an electric motor accommodation chamber in the first case.

19. The clutch control device according to claim 17,
wherein, in a direction orthogonal to the straight line as seen in the axial direction, each gear of the reduction gear mechanism is arranged within a width of an accommodation portion forming an electric motor accommodation chamber in the first case.

20. The clutch control device according to claim 16,
wherein the clutch control device further comprises a fixing member fixed to the accommodation portion forming the electric motor accommodation chamber in the first case,
wherein the fixing member comprises a fastening portion fastened to a machine-side portion in a direction orthogonal to the axial direction, and
wherein the fastening portion forms a bolt insertion hole having an elliptical shape that is long in the axial direction.

21. The clutch control device according to claim 17,
wherein the clutch control device further comprises a fixing member fixed to the accommodation portion forming the electric motor accommodation chamber in the first case,
wherein the fixing member comprises a fastening portion fastened to a machine-side portion in a direction orthogonal to the axial direction, and
wherein the fastening portion forms a bolt insertion hole having an elliptical shape that is long in the axial direction.
